(19) United States
(12) Patent Application Publication
(10) Pub. No.: US 2024/0253390 A1
(43) Pub. Date: Aug. 1, 2024

(54) PAINT BRUSH HOLDING APPARATUS

(71) Applicant: Imagine The Solution, LLC, Detroit, MI (US)

(72) Inventor: Rene C. Torres, Saginaw, MI (US)

(73) Assignee: Imagine The Solution, LLC, Detroit, MI (US)

(21) Appl. No.: 18/408,807

(22) Filed: Jan. 10, 2024

Related U.S. Application Data
(63) Continuation-in-part of application No. 18/104,572, filed on Feb. 1, 2023.
(60) Provisional application No. 63/306,026, filed on Feb. 2, 2022.
(60) Provisional application No. 63/306,030, filed on Feb. 2, 2022.

(51) Int. Cl. B44D 3/12

(52) U.S. Cl. CPC B44D 3/123; B44D 3/126

(57) ABSTRACT

Embodiments herein are directed to a holding apparatus for a paint tray. The holding apparatus for the paint tray includes a trough and a body member. The body member includes an attachment structure attached to the body member, a first retaining member extending from the body member, and a second retaining member extending from the body member. The attachment structure grasping a wall of the paint tray, wherein the body member is positioned within a volume of the paint tray. The first retaining member positioned above the volume of the paint tray in a vertical direction. The second retaining member positioned above the trough in the vertical direction. The trough is releasably coupled to the body member and the trough is positioned outboard of the volume of the paint tray.

### CROSS-REFERENCE TO RELATED APPLICATIONS

This application is a continuation in part of U.S. patent application Ser. No. 18/104,572, filed Feb. 1, 2023, entitled Paint Brush Holding Apparatus, which itself in turn claims priority to U.S. Provisional Application Ser. No. 63/306,026, filed Feb. 2, 2022, and U.S. Provisional Application Ser. No. 63/306,030, filed Feb. 2, 2022, the contents of which are incorporated herein by reference.

### FIELD OF THE INVENTION

The instant application is directed to a paintbrush holding apparatus.

### BACKGROUND OF THE INVENTION

Generally, when a painter is painting with both paintbrushes and a roller in the paint tray more than likely one of the tools will end up in the tray while the other is being used. Sometimes the painter is painting with two different size paintbrushes at once to cut in different corners and paint around edges. When the paintbrushes are not the tool being utilized, they are often laid in the paint tray and eventually fall in the paint getting covered in paint. This results in wasted time cleaning the tool and potentially resulting in messy painting conditions.

Accordingly, a paintbrush holding structure that attaches to a tray and provides a separate holding structure is desirable. Further, there is a need in the art for a paintbrush holding structure that is positioned outboard of the paint tray.

### SUMMARY OF THE INVENTION

In one aspect, a holding apparatus for a paint tray is provided. The holding apparatus for the paint tray includes a trough and a body member. The body member includes an attachment structure attached to the body member, a first retaining member extending from the body member, and a second retaining member extending from the body member. The attachment structure grasping a wall of the paint tray, wherein the body member is positioned within a volume of the paint tray. The first retaining member positioned above the volume of the paint tray in a vertical direction. The second retaining member positioned above the trough in the vertical direction. The trough is releasably coupled to the body member and the trough is positioned outboard of the volume of the paint tray.

In another aspect, a holding apparatus for a paint tray is provided. The holding apparatus for the paint tray includes a trough having a pair of resilient members extending from a rear wall and a body member. The body member includes a planar wall, an attachment structure, a first retaining member, and a second retaining member. The planar wall has an exterior surface, an opposite interior surface, and a pair of openings. The attachment structure includes a continuous wall and at least one holding tang. The continuous wall extends from the exterior surface of the body member. The continuous wall defines a recess. The pair of openings are positioned within the recess defined by the continuous wall. The at least one holding tang extends from the exterior surface of the planar wall. The at least one holding tang is configured to grasp a wall of the paint tray, wherein at least a portion of the planar wall is positioned within a volume of the paint tray. The first retaining member extends from the body member and is positioned above the volume of the paint tray in a vertical direction. The second retaining member extends from the body member and is positioned above the trough in the vertical direction. The pair of resilient members configured to be received by the pair of openings to releasably couple the trough to the planar wall, the trough is positioned outboard of the volume of the paint tray.

In a further aspect, a holding apparatus for a paint tray having a volume is provided. The holding apparatus for the paint tray having the volume includes a trough having a pair of resilient members extending from a rear wall, a body member, a first retaining member, and a second retaining member. The body member includes a planar wall having an exterior surface, an opposite interior surface, and a pair of openings. The attachment structure includes a continuous wall extending from the exterior surface of the body member. The continuous wall defines a recess. The pair of openings positioned within the recess defined by the continuous wall. The at least one holding tang extends from the exterior surface of the planar wall. The at least one holding tang includes a body that extends from the continuous wall and transitions at a first radius in a first direction and transitions at a second radius in a second direction opposite to the first direction to define a spring clip. The at least one holding tang configured to grasp a wall of the paint tray. The first retaining member extends from the body member and positioned above the volume of the paint tray in a vertical direction. The second retaining member extending from the body member and positioned above the trough in the vertical direction. The pair of resilient members are configured to be received by the pair of openings to releasably couple the trough to the planar wall in a snap-fit configuration. The trough is positioned outboard of the volume of the paint tray and at least a portion of the planar wall is positioned within the volume of the paint tray.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, where like structure is indicated with like reference numerals and in which:

FIG. 1 is a perspective view of one embodiment of a paintbrush holding structure attached to a paint tray according to one or more embodiments shown and described herein;

FIG. 2 is a perspective view of one embodiment of a paintbrush holding structure of FIG. 1 according to one or more embodiments shown and described herein;

FIG. 3 is a top view of another embodiment of a paintbrush holding structure attached to a paint tray according to one or more embodiments shown and described herein;

FIG. 4 is a perspective view of another embodiment of a paintbrush holding structure attached to a paint tray according to one or more embodiments shown and described herein;

FIG. 5 is a back view of another embodiment of a paintbrush holding structure; of FIG. 4 according to one or more embodiments shown and described herein:

FIG. 6 is a side perspective of another embodiment of a paintbrush holding structure; of FIG. 4 according to one or more embodiments shown and described herein;

FIG. 7 is a top perspective view of another embodiment of a paintbrush holding structure of FIG. 4 according to one or more embodiments shown and described herein;

FIG. 8 is a top perspective view of another embodiment of a paintbrush holding structure according to one or more embodiments shown and described herein;

FIG. 9 is a side perspective view of another embodiment of a paintbrush holding structure of FIG. 8 according to one or more embodiments shown and described herein;

FIG. 10 is a front view of another embodiment of a paintbrush holding structure of FIG. 8 according to one or more embodiments shown and described herein;

FIG. 11 schematically depicts a side perspective view of another embodiment of a paintbrush holding structure attached to a paint tray according to one or more embodiments shown and described herein;

FIG. 12 schematically depicts a top perspective view of the paintbrush holding structure attached to the paint tray of FIG. 11 according to one or more embodiments shown and described herein;

FIG. 13 schematically depicts a side perspective view of the paintbrush holding structure attached to the paint tray of FIG. 11 according to one or more embodiments shown and described herein;

FIG. 14 schematically depicts an other side perspective view of the paintbrush holding structure attached to the paint tray of FIG. 11 according to one or more embodiments shown and described herein;

FIG. 15 schematically depicts an isolated perspective view of the paintbrush holding structure of FIG. 11 according to one or more embodiments shown and described herein;

FIG. 16 schematically depicts an isolated top-down view of the paintbrush holding structure of FIG. 15 according to one or more embodiments shown and described herein;

FIG. 17 schematically depicts an isolated side view of the paintbrush holding structure of FIG. 15 according to one or more embodiments shown and described herein;

FIG. 18 schematically depicts an isolated top-down and perspective view of the paintbrush holding structure of FIG. 15 according to one or more embodiments shown and described herein;

FIG. 19 schematically depicts an isolated top-down view of a paint trough of the paintbrush holding structure of FIG. 15 according to one or more embodiments shown and described herein; and

FIG. 20 schematically depicts an isolated perspective view of a planar wall and retaining member of the paintbrush holding structure of FIG. 15 according to one or more embodiments shown and described herein.

### DETAILED DESCRIPTION OF THE EMBODIMENTS

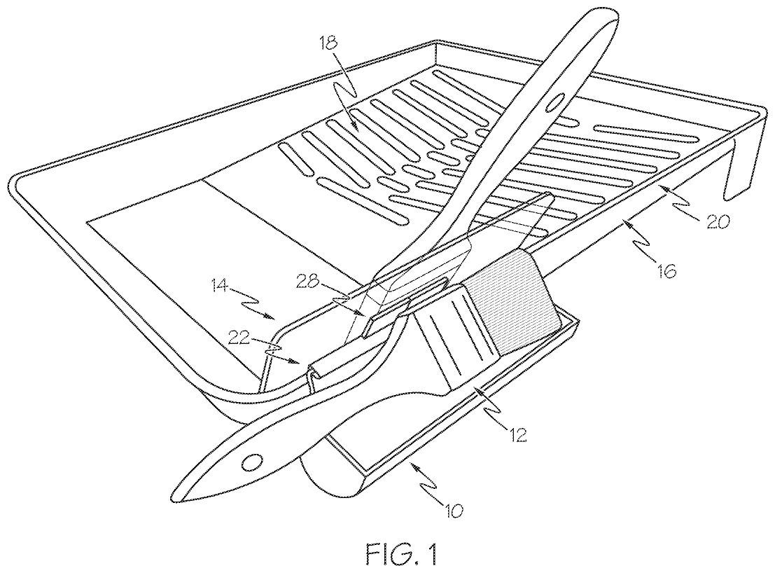

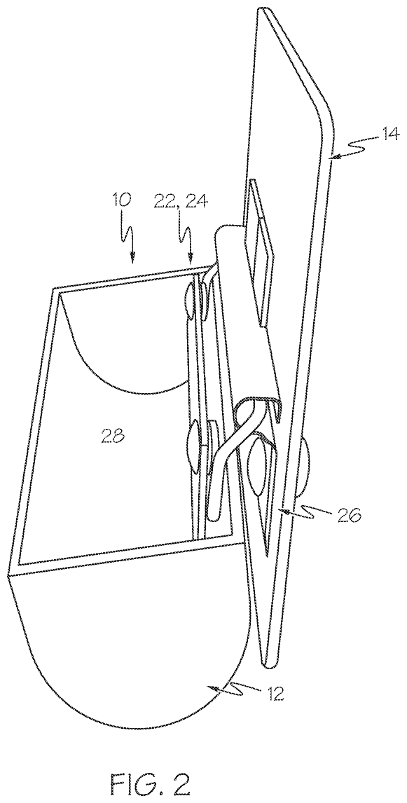

Referring to FIGS. 1 and 2, there is shown one embodiment of a paintbrush holding apparatus 10. In the depicted embodiment, the paintbrush holding apparatus 10 includes a paint trough 12 attached to a brush holding body 14. The brush holding body 14 may be positioned within a paint tray 16. The trough 12 may have various lengths and widths to be attached to various sized trays 16.

The tray 16 includes a base surface 18 having a plurality of upstanding walls 20 that are joined to define a volume of the paint tray 16. In one aspect, the term upstanding walls 20 may also include the walls of a liner that may be positioned in the paint tray 16.

The brush holding body 14 includes an attachment structure 22 attached thereon. The attachment structure includes a clamping structure 24 having two separate halves 26 that grasp a wall 20 of the paint tray 16 as shown in FIG. 1. It should be realized that various numbers of paintbrush holding apparatus 10 may be attached to the paint tray 16.

The brush holding body 14 includes a magnetic portion 28 formed or attached thereon. The magnetic portion 28 magnetically grasps the ferrule of a paintbrush. The magnetic portion 28 is structured to hold the ferrule of the brush and maintain the paintbrush out of the paint within the paint tray 16.

Additionally, the magnetic portion 28 may hold the brush outside of the paint tray 16 and above or within the trough, as shown in FIG. 1. The trough 12 may catch any potential residual paint on the brush. Alternatively, the trough 12 may receive paint and the brush may be used with the paint contained in the trough 12.

In use, a person may attach the paintbrush holding apparatus 10 to a wall 20 of the paint tray 16. The attachment structure 22 is locked such that the clamps securely grasp the wall 20 of the tray 16. As stated above, wall may include a liner that is positioned in the tray. In such a case, the liner may be securely clamped as well between the tray 16 and the clamps. The brush holding body 14 is positioned in the inner volume of the paint tray 16. The trough 12 is positioned outboard of the paint tray 16. The magnetic portion 28 may hold a paintbrush above or within the tray 16 or above or within the trough 12.

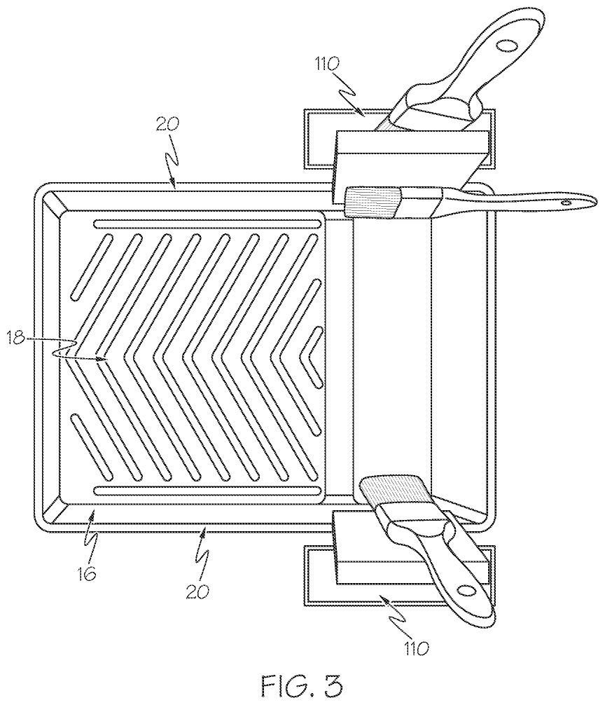

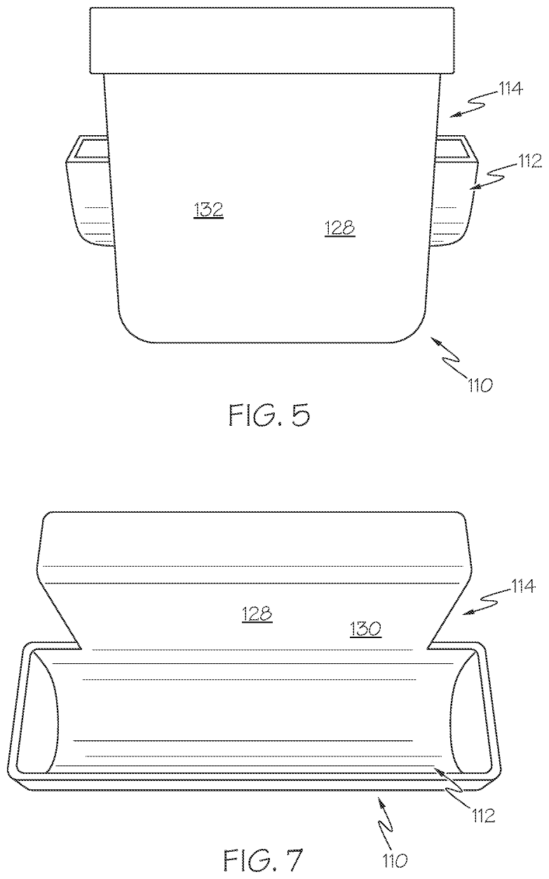

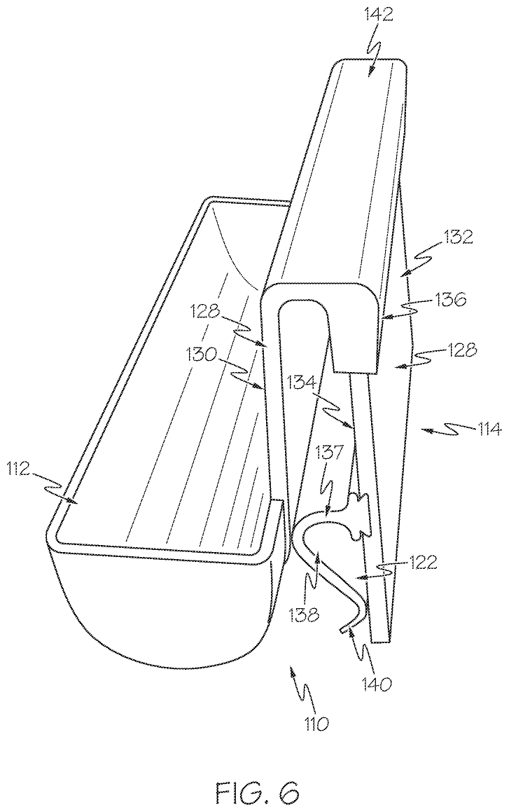

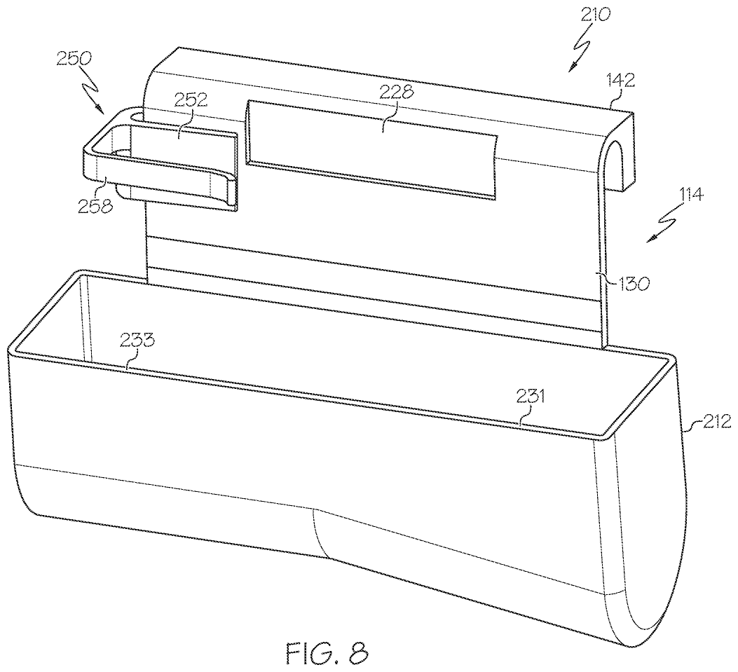

Referring to FIGS. 3-7, there is shown another embodiment of the paintbrush holding apparatus 110. In the depicted embodiment, the paintbrush holding apparatus 110 includes a paint trough 112 coupled or formed with a brush holding body 114. The trough 112 may have various lengths and widths to be attached to various sized trays 16.

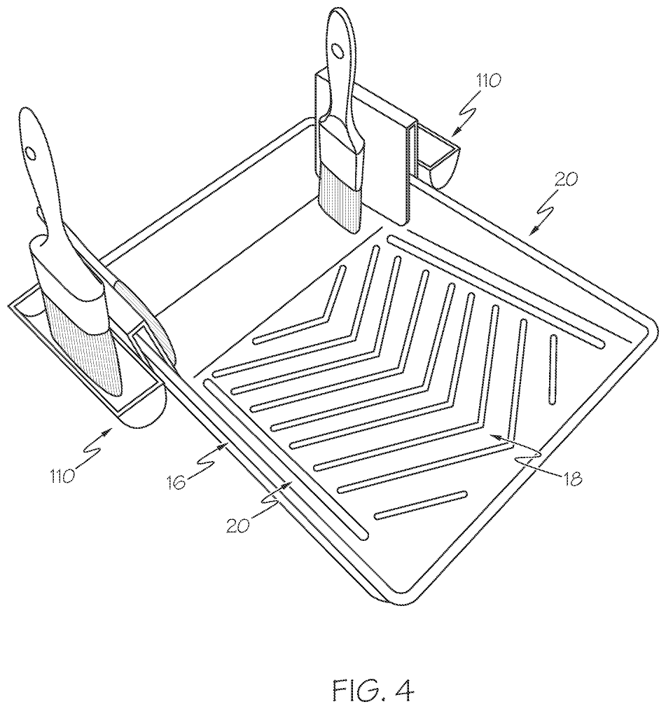

The brush holding body 114 may include an inner portion 130 separated from an outer portion 132. The outer portion 132 is positioned within a boundary or inner volume of the tray 16. The outer portion 132 includes inner and outer surfaces 134, 136. The inner surface 134 includes an attachment structure 122 formed or attached thereon. The attachment structure 122 may include a holding tang 138 having a body 140 that extends from the outer surface 136 and then curves at a radius 137 to define a spring clip 140. The spring clip 140 flexes at the radius 137 to securely grasp the wall 20 of the tray 16, as shown in FIGS. 3 and 4. As stated above, the wall 20 may include a liner that is positioned in the tray. In such a case, the liner may be securely grasped as well between the tray 16 and the spring clip 140.

The brush holding body 114 includes an outer portion 132 joined and separated from the inner portion 130 by a coupler 142. The inner portion 130 includes the trough 112 attached or formed thereon.

The brush holding body 114 includes a magnetic portion 128 formed or attached thereon on both the inner and outer portions 130, 132. The magnetic portion 128 magnetically grasps the ferrule of a paintbrush. The magnetic portion 128 is structured to hold the ferrule of the brush and maintain the paintbrush out of the paint within the paint tray 16.

Additionally, the magnetic portion 128 may hold the brush outside of the paint tray 16 and above or within the trough 112, as shown in FIGS. 3 and 4. The trough 112 may catch any potential residual paint on the brush. Alternatively, the trough 112 may receive paint and the brush may be used with the paint contained in the trough.

In use, a person may attach the paintbrush holding apparatus 110 to a wall 20 of the paint tray 16. The wall 20 of the tray 16 is positioned in the spring clip 140 and securely grasps the wall 20 of the tray 16. The brush holding body 114 is positioned in the inner volume of the paint tray 16. The trough 112 is positioned outboard of the paint tray 16. The magnetic portion 128 may hold a paintbrush above or within the tray 16 or above or within the trough 112.

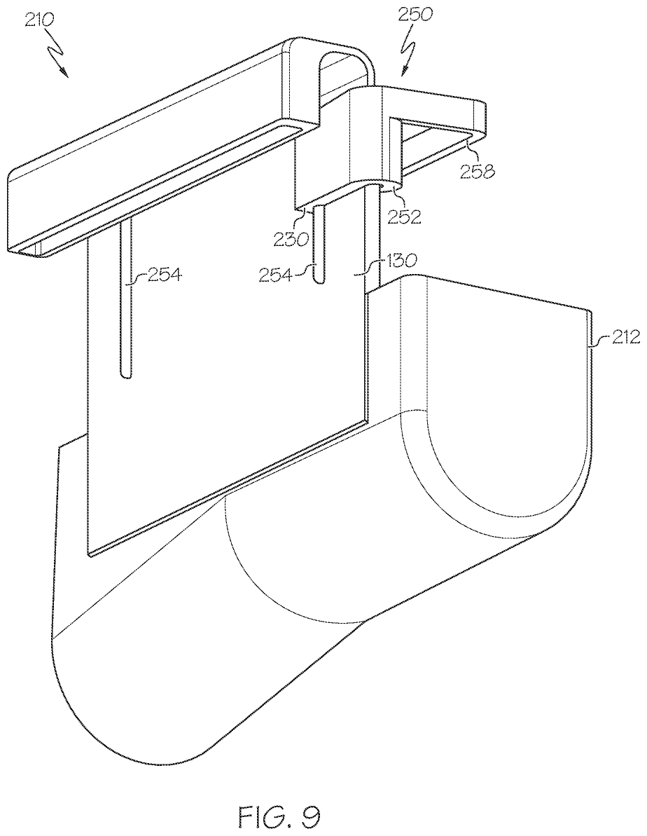

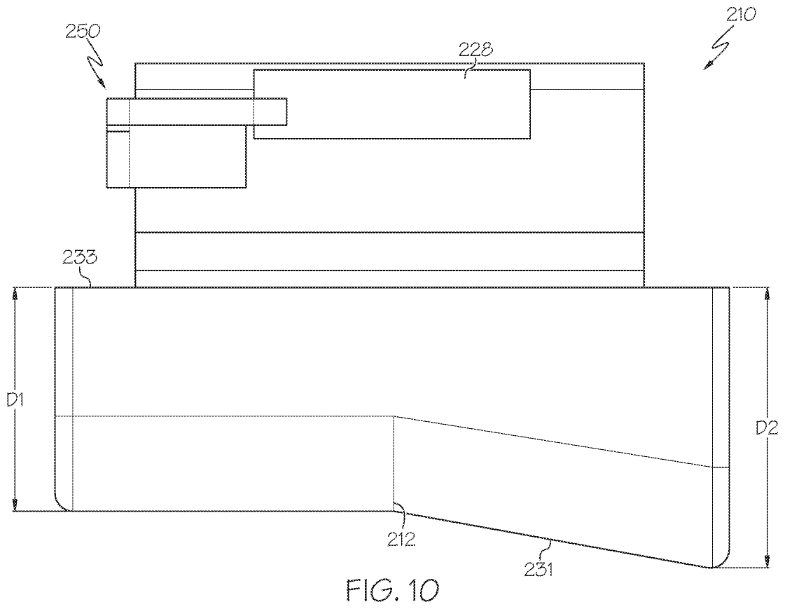

Referring to FIGS. 8-10, there is shown another embodiment of the paintbrush holding apparatus 210. In the depicted embodiment, the paintbrush holding apparatus 210 includes a paint trough 212 coupled or formed with a brush holding body 114. The trough 212 may have various lengths and widths to be attached to various sized trays 16. In one aspect, the trough may include an angled portion 231 formed thereon. The angled portion 231 may have a deeper depth D2 relative to a depth D1 of the non-angled portion 233 of the trough 212. The angled portion 231 may be used to accommodate angled paint brushes. It should be realized that the trough 212 may also be utilized to hold a paint roller.

The brush holding body 114 may include an inner portion 130 separated from an outer portion 232. The outer portion 132 is positioned within a boundary or inner volume of the tray 16. The outer portion 132 includes inner and outer surfaces 134, 136 (best seen above). In the depicted embodiments, the outer portion 132 including an attachment structure 122 as described above and is removed for clarity in FIGS. 8-10. The attachment structure 122 is the same as that described above with reference to FIGS. 3-7. The brush holding body 114 includes an outer portion 132 joined and separated from the inner portion 130 by a coupler 142. The inner portion 130 includes the trough 212 attached or formed thereon.

The brush holding body 114 includes a magnetic portion 228 formed or attached thereon on both the inner and outer portions 130, 132 as described above. The magnetic portion 228 magnetically grasps the ferrule of a paintbrush. The magnetic portion 228 is structured to hold the ferrule of the brush and maintain the paintbrush out of the paint within the paint tray 16.

Additionally, the magnetic portion 228 may hold the brush outside of the paint tray 16 and above or within the trough 212. The trough 212 may catch any potential residual paint on the brush. Alternatively, the trough 212 may receive paint and the brush may be used with the paint contained in the trough.

In the depicted embodiment, a brush clip 250 may be attached to the inner portion 130. Various numbers of clips 250 may be attached on different sides of the inner portion 130. The brush clip 250 may include a generally U-shaped attachment portion 252 that receives the inner portion 130. The back surface of the inner portion 130 may include beads 254 formed thereon on opposing sides of the inner portion 130. The beads 254 are received in notches 256 formed in the generally U-shaped attachment portion 252. The clips 250 also include a grip portion 258 formed thereon. The grip portion 258 may grasp a handle of a paintbrush.

In use, a person may attach the paintbrush holding apparatus 210 to a wall 20 of the paint tray 16. The wall 20 of the tray 16 is positioned in the spring clip 140 and securely grasps the wall 20 of the tray 16. The brush holding body 114 is positioned in the inner volume of the paint tray 16. The trough 212 is positioned outboard of the paint tray 16. The magnetic portion 228 may hold a paintbrush above or within the tray 16 or above or within the trough 212.

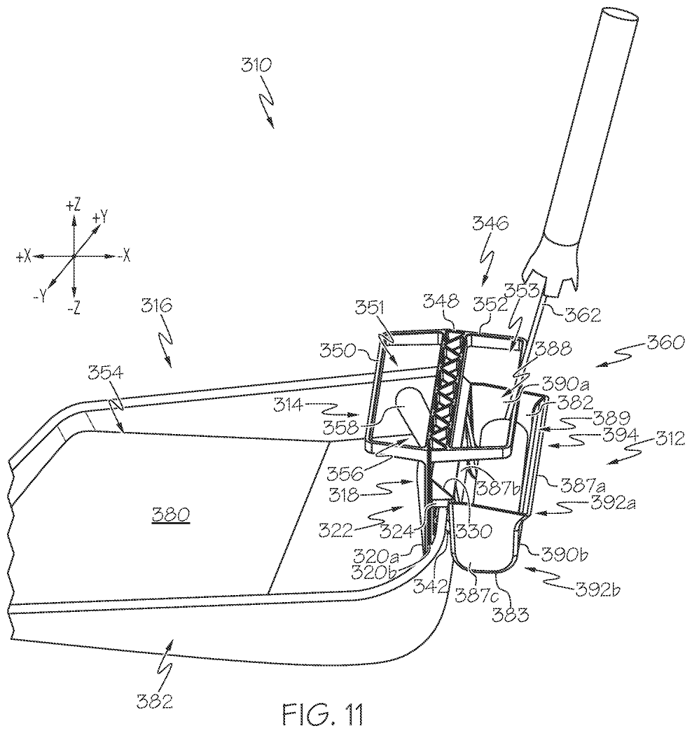

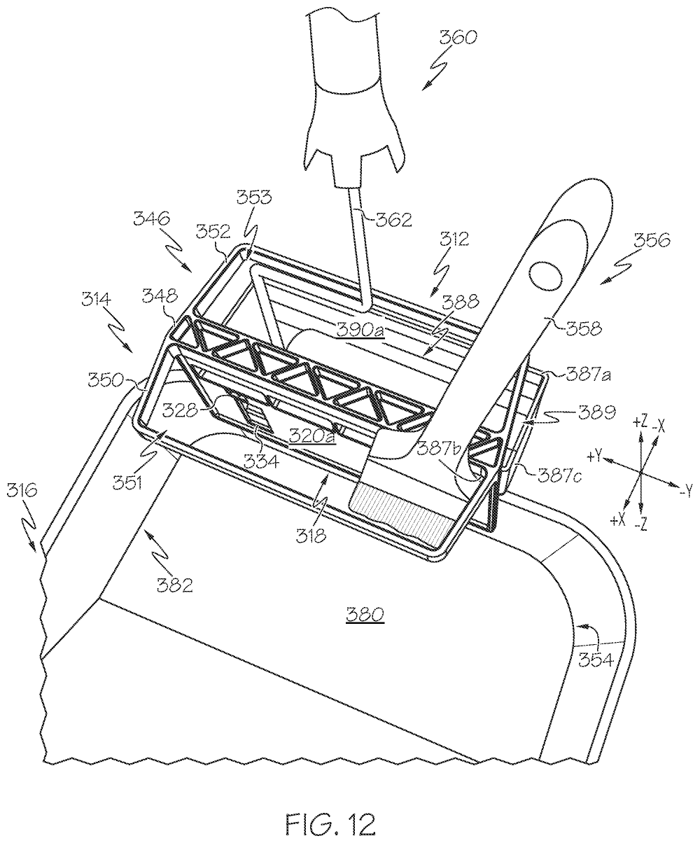

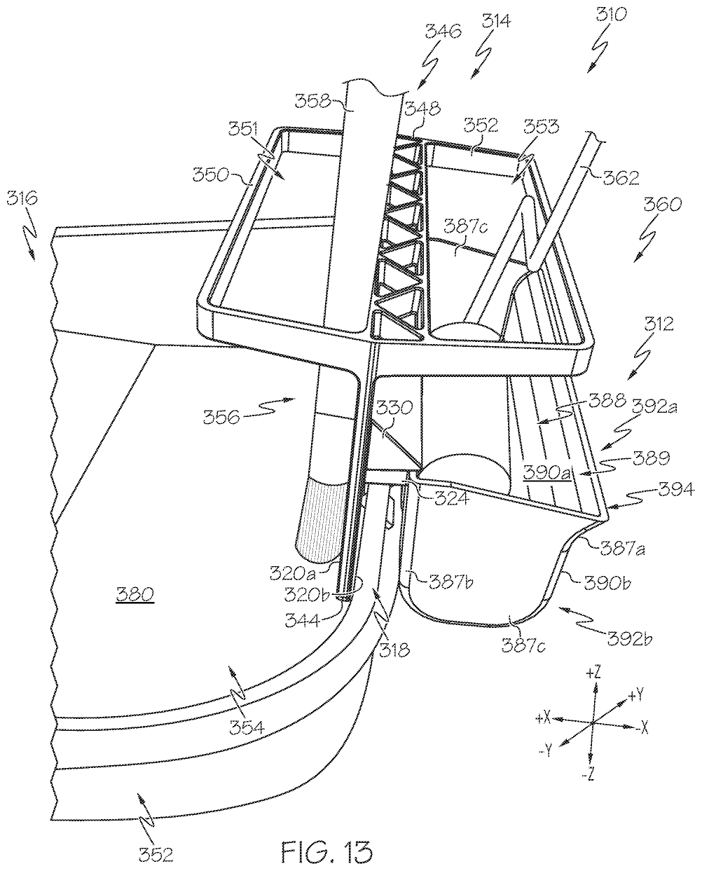

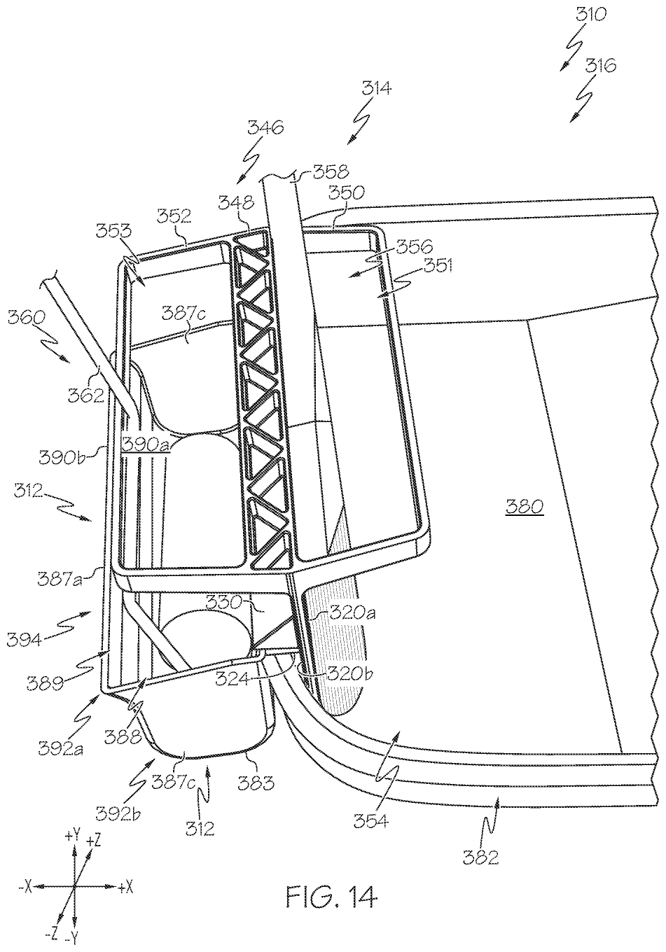

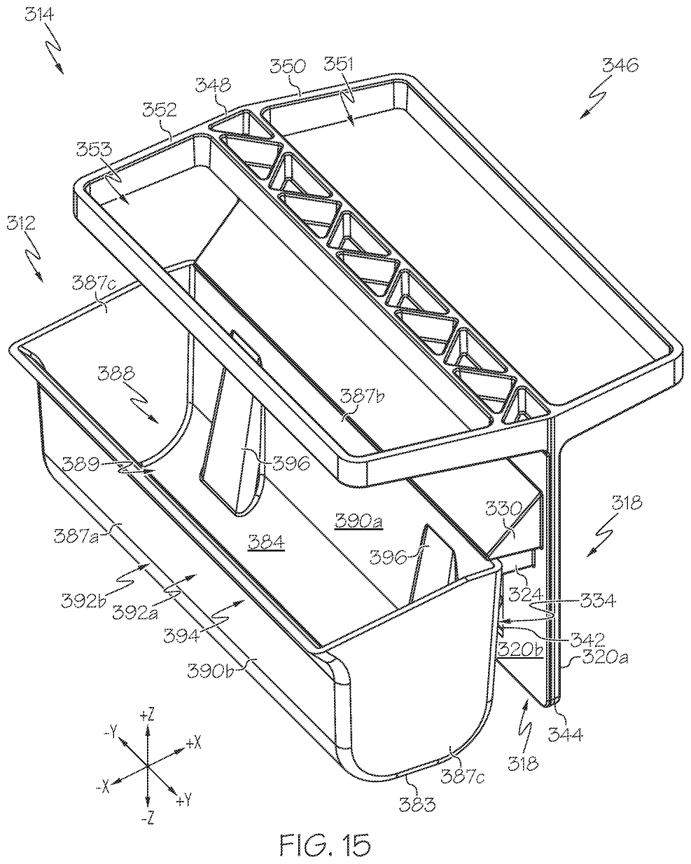

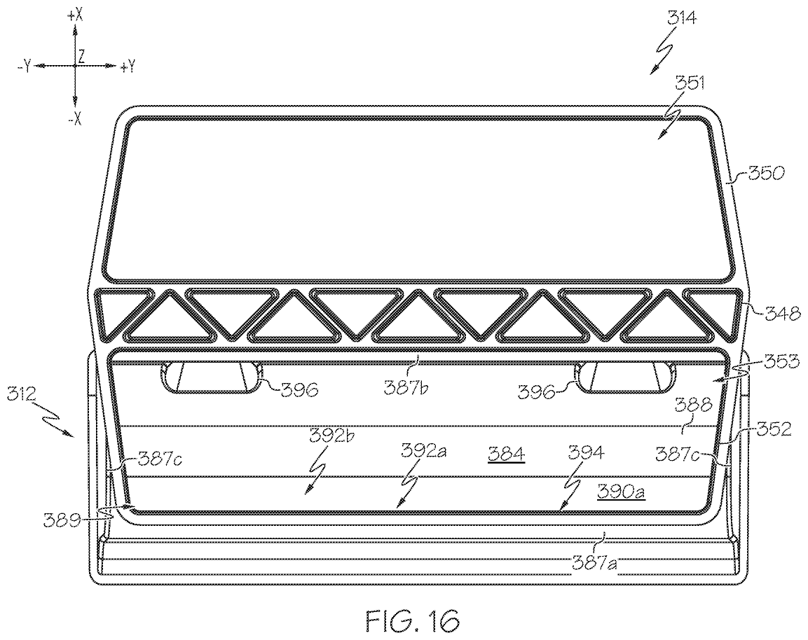

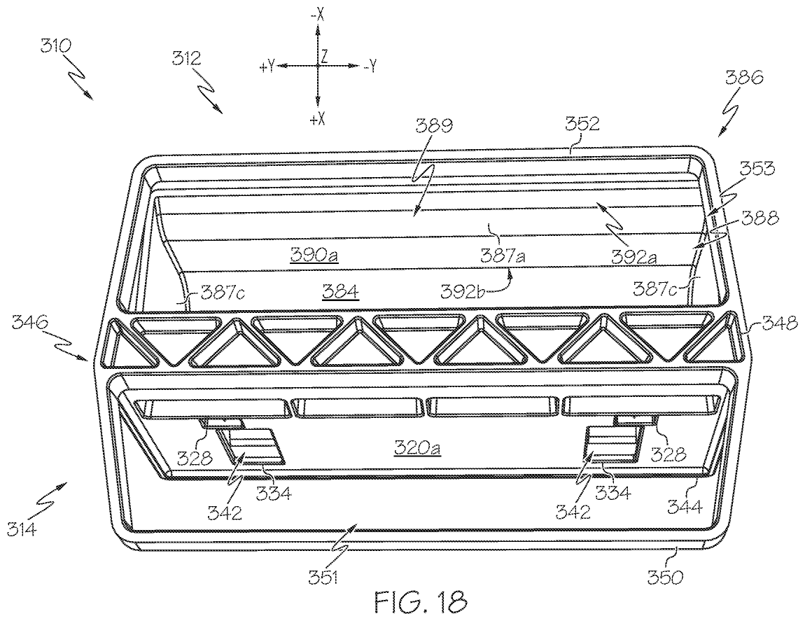

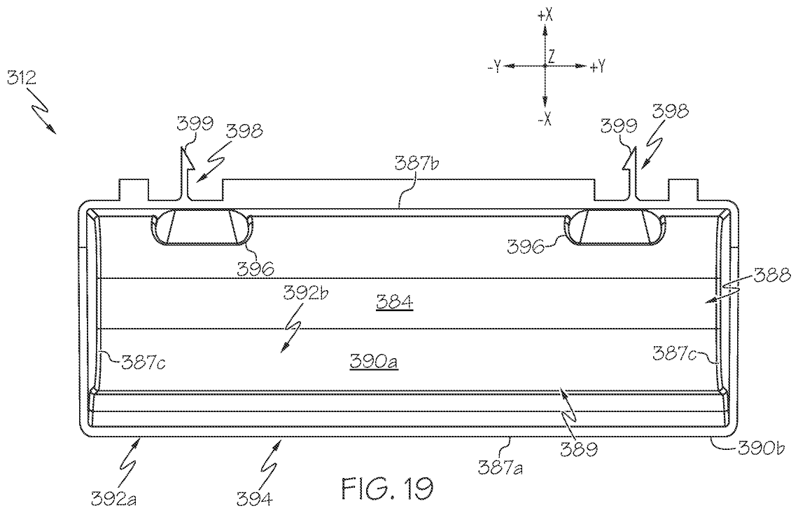

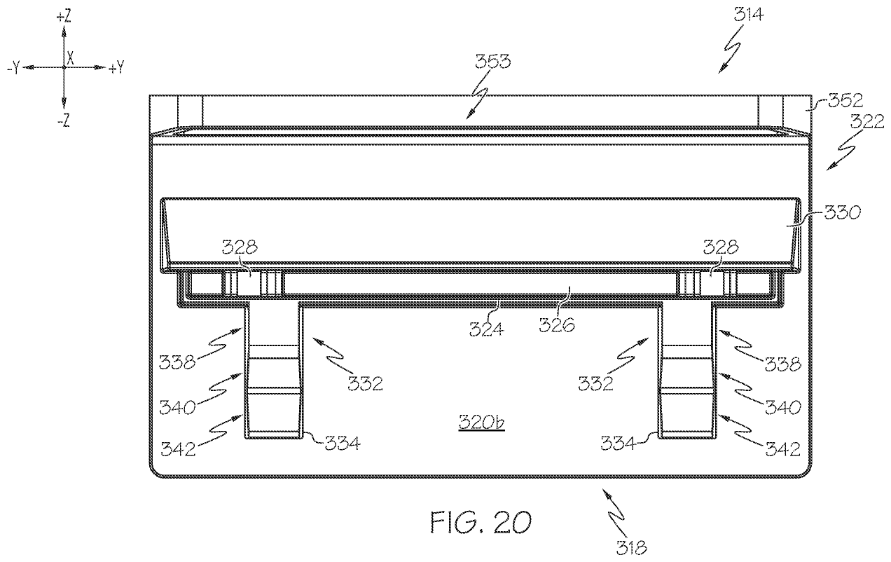

Now referring to FIGS. 11-19, another aspect of a paintbrush holding apparatus 310 attached to a paint tray 316 is schematically depicted. It is understood that the paintbrush holding apparatus 310 attached to the paint tray 316 may be similar to, and/or include any of the features of any of the previous embodiments depicted in FIGS. 1-10 with the exception of the features described herein.

As used herein, the term “longitudinal direction” refers to the forward-rearward direction of the paintbrush holding apparatus 310 (i.e., in the +/−X-direction depicted in FIG. 11). The term “lateral direction” refers to the cross-direction of the paintbrush holding apparatus 310 (i.e., in the +/−Y-direction depicted in FIG. 11), and is transverse to the longitudinal direction. The term “vertical direction” or “below” or “above” refer to the upward-downward direction of the paintbrush holding apparatus 310 (i.e., in the +/−Z-direction depicted in FIG. 11).

Referring now to FIGS. 11-19, the paintbrush holding apparatus 310 includes a paint trough 312 attached or coupled to a body member 314, which is coupled or attached to a paint tray. The paint tray 316 may include a base surface 380 and includes a plurality of upstanding or upright walls 382 that are joined to define a volume 354 of the paint tray 316. In one aspect, the term upstanding walls 382 may also include walls of a liner that may be positioned within the paint tray 316.

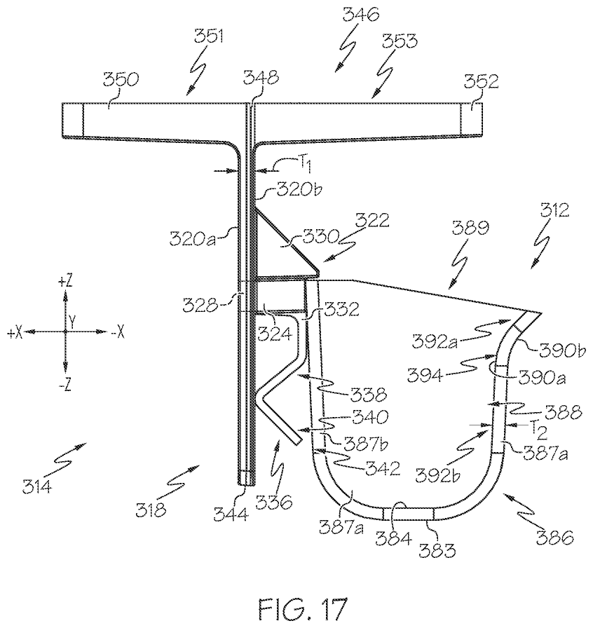

The body member 314 may include a planar wall 318 that includes an interior surface 320a and an opposite exterior surface 320b spaced apart from the interior surface 320a to define a thickness T1, as best illustrated in FIG. 17. When coupled to the paint tray 316, the interior surface 320a faces the paint tray 316 while the exterior surface 320b faces the paint trough 312, in a direction opposite of the paint tray 316.

The planar wall 318 may further include an attachment structure 322. The attachment structure 322 may include a continuous wall 324 extending from the exterior surface 320b of the planar wall 318 to define a recess portion 326, a pair of spaced apart openings 328 configured to receive a portion of the paint trough 312, a support member 330 that may extend from the exterior surface 320b of the planar wall 318, and at least one holding tang 332 extending from the exterior surface 320b of the planar wall 318.

In the depicted embodiment, the continuous wall 324 is generally rectangular shaped. This is non-limiting and the continuous wall 324 may be any shape including square, elliptical, hexagonal, octagonal, circular, and/or the like. Positioned within the recess portion 326 and surrounded by the continuous wall 324 is a pair of spaced apart openings 328 configured to receive a portion of the paint trough 312, as discussed in greater detail herein. Each of the pair of openings 328 extend through the thickness T1 of the planar wall 118. Each of the pair of openings 328 may be any shape including, without limitation, circular, rectangular, square, hexagonal, octagonal, symmetric, unsymmetrical, elliptical, and/or the like.

In some embodiments, other openings 334 may be positioned in the planar wall 318 and extend through the thickness T1 of the planar wall 318. The other openings 334 may be any shape including, without limitation, circular, rectangular, square, hexagonal, octagonal, symmetric, unsymmetrical, elliptical, and/or the like.

The support member 330 may be positioned to be above the continuous wall 324 in the vertical direction (i.e., in the +/−Z direction), as best illustrated in FIG. 17. Further, the support member 330 may extend beyond the continuous wall 324 in the longitudinal direction (i.e., in the +/−X direction) to cover the continuous wall 324, as best illustrated in FIG. 17. In the depicted embodiment, the support member 330 may generally be a triangular shape with a base portion extending along and beyond the continuous wall 324, a height extending along or from the exterior surface 320b, and a hypotenuse extending from the exterior surface 320b to the base beyond the continuous wall 324. In other embodiments, the support member 330 may be any shape including, without limitation, circular, rectangular, square, hexagonal, octagonal, symmetric, unsymmetrical, elliptical, and/or the like.

The at least one holding tang 332 may include a body 336 that extends from the exterior surface 320b and/or from the continuous wall 324, and then curves at a first radius 338 in one direction and curves at a second radius 340 in a second direction generally opposite the one direction to define a spring clip 342. As such, the at least one holding tang 332 may have resilient contact with the paint trough 312 and/or with the paint tray 316 to securely grasp the paint tray 316 between portions of the spring clip 342 and the exterior surface 320b of the planar wall 318, below the continuous wall 324 in the vertical direction (i.e., in the +/−Z direction), as discussed in greater detail herein.

Further, the planar wall includes a terminating edge 344 at a distal end (e.g., at the lowermost portion of the planar wall 318 in the −Z direction) and a retaining portion 346 extending from a proximal end (e.g., at the uppermost portion of the planar wall 118 in the +Z direction) such that the proximal end is above the distal end in the vertical direction (i.e., in the +/−Z direction).

The retaining portion 346 includes a connector portion 348, a first retaining member 350, and a second retaining member 352. The connector portion 348 extends from or is part of the planar wall 318. The first retaining member 350 and the second retaining member 352 each extend from the connector portion 348 in opposite directions. That is, the first retaining member 350 extends in a direction to be towards the paint tray 316 when the body member 314 is coupled or otherwise attached to the paint tray 316. The second retaining member 352 extends in a direction to be towards the paint trough 312 when the paint trough 312 is coupled or otherwise attached to the body member 314. As such, the first retaining member 350 may be positioned above a volume 354 of the paint tray 316 in the vertical direction (i.e., in the +/−Z direction).

In the depicted embodiments, the first retaining member 350 is a u-shape with an opening 351 defined by the first retaining member 350 and the connector portion 348. The opening 351 is configured to retain at least a portion of a handle 358 of a brush 356 such that the brush 356 is maintained within and between the paint tray 316 and the opening 351 defined by the first retaining member 350 and the connector portion 348, as best illustrated in FIGS. 11-14, and as discussed in greater detail herein. It should be understood that the shape of the first retaining member 350 is non-limiting, and may be, for example, square, hexagonal, octagonal, curvilinear, arcuate, irregular, non-uniform or unsymmetrical, and the like. Further, the shape and size of the opening 351 is non-limiting, and may be, for example, square, hexagonal, octagonal, curvilinear, arcuate, irregular, non-uniform or unsymmetrical, and the like.

In the depicted embodiments, the second retaining member 352 may be positioned above the paint trough 312 in the vertical direction (i.e., in the +/−Z direction). The second retaining member 352 is a u-shape with an opening 353 defined by the second retaining member 352 and the connector portion 348. The opening 353 is configured to retain at least a portion of a handle of a brush such that the brush is maintained within and between the paint trough 312 and the opening 353 defined by the second retaining member 352 and the connector portion 348. Alternatively, or in addition to, the opening 353 is configured to retain at least a portion of a frame 362 of a paint roller assembly 360 such that the paint roller assembly 360 is maintained or retained within and between the paint trough 312 and the opening 353 defined by the second retaining member 352 and the connector In other embodiments, both the paint roller assembly 360 and the brush, or more than one brush may be positioned and retained within the opening 353.

It should be understood that the shape of the second retaining member 352 is non-limiting, and may be, for example, square, hexagonal, octagonal, curvilinear, arcuate, irregular, non-uniform or unsymmetrical, and the like. Further, the shape and size of the opening 353 is non-limiting, and may be, for example, square, hexagonal, octagonal, curvilinear, arcuate, irregular, non-uniform or unsymmetrical, and the like.

The various features of the body member 314 (e.g., the planar wall 318, the attachment structure 322, and the like) may be formed integrally, as a single monolithic component, or as any suitable number of sub-components. For example, the various features of the body member 314 may be formed via injection molding, additively manufactured, and/or the like. As used herein, the terms “additively manufactured” refer generally to manufacturing processes wherein successive layers of material(s) are provided on each other to “build-up.” layer-by-layer, a three-dimensional component. The successive layers generally fuse together to form a monolithic component which may have a variety of integral sub-components. Although additive manufacturing technology is described herein as enabling fabrication of complex objects by building objects point-by-point, layer-by-layer, typically in a vertical direction, other methods of fabrication are possible and within the scope of the present subject matter. For example, although the discussion herein refers to the addition of material to form successive layers, one skilled in the art will appreciate that the methods and structures disclosed herein may be practiced with any additive manufacturing technique or manufacturing technology. For example, embodiments of the present invention may use layer-additive processes, layer-subtractive processes, or hybrid processes.

Suitable additive manufacturing techniques in accordance with the present disclosure include, for example, Fused Deposition Modeling (FDM), Selective Laser Sintering (SLS), 3D printing such as by inkjets and laserjets, Sterolithography (SLA), Direct Selective Laser Sintering (DSLS), Electron Beam Sintering (EBS), Electron Beam Melting (EBM), Laser Engineered Net Shaping (LENS), Laser Net Shape Manufacturing (LNSM), Direct Metal Deposition (DMD), Digital Light Processing (DLP), Direct Selective Laser Melting (DSLM), Selective Laser Melting (SLM), Direct Metal Laser Melting (DMLM), and other known processes.

The additive manufacturing processes described herein may be used for forming components using any suitable material. For example, the material may be plastic, metal, concrete, ceramic, polymer, epoxy, photopolymer resin, or any other suitable material that may be in solid, liquid, powder, sheet material, wire, or any other suitable form. In addition, one skilled in the art will appreciate that a variety of materials and methods for bonding those materials may be used and are contemplated as within the scope of the present disclosure. As used herein, references to “fusing” may refer to any suitable process for creating a bonded layer of any of the above materials. For example, if an object is made from polymer, fusing may refer to creating a thermoset bond between polymer materials. If the object is epoxy, the bond may be formed by a crosslinking process. If the material is ceramic, the bond may be formed by a sintering process. If the material is powdered metal, the bond may be formed by a melting or sintering process. One skilled in the art will appreciate that other methods of fusing materials to make a component by additive manufacturing are possible, and the presently disclosed subject matter may be practiced with those methods.

In addition, the additive manufacturing process disclosed herein allows a single component to be formed from multiple materials. Thus, the components described herein may be formed from any suitable mixtures of the above materials. For example, a component may include multiple layers, segments, or parts that are formed using different materials, processes, and/or on different additive manufacturing machines. In this manner, components may be constructed which have different materials and material properties for meeting the demands of any particular application. In addition, although the components described herein are constructed entirely by additive manufacturing processes, it should be appreciated that in alternate embodiments, all or a portion of these components may be formed via casting, machining, and/or any other suitable manufacturing process. Indeed, any suitable combination of materials and manufacturing methods may be used to form these components.

In operation, the portions of the body member 314 may be positioned within the paint tray 316 and the attachment structure 322 secures the body member 314 to one of the upright walls 382 of the paint tray 316. The attachment structure 322 is frictionally locked by the at least one holding tang 332 applying a pressure to the upright wall 382 to push or secure the wall against a portion of the exterior surface 320b of the planar wall 318 and the continuous wall 324. As stated above, the upright wall 382 may include a liner that is positioned in the paint tray 316. In such a case, the liner may be securely clamped as well between the paint tray 316 and the at least one holding tang 332. The first retaining member 350 is positioned in the volume 354 of the paint tray 316.

The paint trough 312 may include a base wall 383 that has a base surface 384 and includes a plurality of upstanding or upright walls 386, such as a front wall 387a, a rear wall 387b, and a pair of sidewalls 387c extending therefrom that are joined to form a continuous inner surface 390a to define a volume 388 of the paint trough 312 with an opening 389 to access the volume 388. In one aspect, the term upstanding or upright walls 386 may also include walls of a liner that may be positioned within the paint trough 312. The paint trough 312 is positioned outboard of the paint tray 316 in the longitudinal direction (i.e., in the +/−X direction). As such, the paint trough 312 and the opening 353 of the second retaining member 352 of the retaining portion 346 may retain or maintain a position of a second or different paintbrush and/or the paint roller assembly 360 outside of the volume 354 of the paint tray 316.

The plurality of upstanding or upright walls 386 further include an outer surface 390b spaced apart and opposite of the interior surface 390a to define a thickness T2 of each of the plurality of upstanding or upright walls 386. In some embodiments, the front wall 387a, the rear wall 387b, and the pair of sidewalls 387c may be a single, continuously formed, monolithic structure that this formed as a single piece or from injection molding techniques, casting, and/or the like. In other embodiments, the front wall 387a, the rear wall 387b, and the pair of sidewalls 387c may be additively manufactured to form the single, continuously formed, monolithic structure. The front wall 387a may include an upper portion 392a, and a lower portion 392b. The upper portion 392a include a radius 394 extending away from the rear wall 387b such that volume 388 is larger near the upper portion 392a than at the lower portion 392b.

Further, in some embodiments, the base wall 383, the front wall 387a and the pair of sidewalls 387c may be, or have portions, that are arcuate or curvilinear. In some embodiments, the rear wall 387b may be linear or planar. In other embodiments, each of the base wall 383, the front wall 387a, the pair of sidewalls 387c, and the rear wall 387b may be, or have portions, that are arcuate or curvilinear. A pair of guide members 396 may be positioned within the volume 388 and may extend from the interior surface 390a of the rear wall 387b and the base surface 384 of the base wall 383.

In the depicted embodiment, the pair of guide members 396 are spaced apart and generally a triangular shape, such as a right triangle. This is non-limiting and the pair of guide members 396 may be other triangular shapes, or may be any shape including, without limitation, circular, rectangular, square, hexagonal, octagonal, symmetric, unsymmetrical, elliptical, and/or the like. Further, there may be more than, or less than, the pair of guide members 396 depicted. The pair of guide members 396 may be configured to help guide the paint roller assembly 360 towards the base surface 384 of the base wall 383.

A pair of resilient members 398 may extend from the exterior surface of the rear wall 387b in the direction opposite of the volume 388 of the paint trough 312. Each of the pair of resilient members 398 may include an angled protrusion 399 that is configured to engage with the interior surface 320a of the planar wall 318 when each of the pair of resilient members 398 is aligned and coupled to the planar wall 318 via the openings 328. As such, the pair of resilient members 398 may be in a snap-fit configuration with the body member 314 to releasably couple the paint trough 312 the exterior surface 320b of the planar wall 318 beyond or outside of the volume 354 of the paint tray 316.

It should now be understood that the embodiments described herein are directed to a paintbrush holding apparatus that includes a paint trough attached to a paint tool holding body. The paint tool holding body may include portions that are positioned within a volume of a paint tray by releasably coupling or attaching to a wall of the paint tray. The trough is releasably coupled to the paint tool holding body and may have various lengths and widths to be attached to various sized trays. The paint tool holding body includes a retaining portion that is configured to retain or maintain a position of a paint brush within the volume of the paint tray and to maintain another paint brush and/or a roller assembly within the trough, outboard or outside of the volume of the paint tray. Such arrangement provides for advantages over conventional apparatus and devices by utilizing the paint tray, adding additional volume to the paint tray, permitting the brush or roller to drip paint into various volumes without the brush or roller assembly falling into the respective volume, positions the paint brush or roller assembly for quick, easy, and repeatable positioning for grasping by a user, and the like.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

I claim:

1. A holding apparatus for a paint tray comprising:
a trough; and
a body member having:
an attachment structure attached to the body member, the attachment structure grasping a wall of the paint tray, wherein the body member is positioned within a volume of the paint tray;
a first retaining member extending from the body member and positioned above the volume of the paint tray in a vertical direction; and
a second retaining member extending from the body member and positioned above the trough in the vertical direction,
wherein the trough is releasably coupled to the body member and the trough is positioned outboard of the volume of the paint tray.

2. The holding apparatus for the paint tray of claim 1, wherein the first retaining member is a u-shape and configured to retain a handle of a brush such that the brush is maintained within and between the paint tray and the first retaining member.

3. The holding apparatus for the paint tray of claim 1, wherein the second retaining member is a u-shape and configured to retain a handle of a brush such that the brush is maintained within and between the trough and the second retaining member.

4. The holding apparatus for the paint tray of claim 1, wherein the second retaining member is a u-shape and configured to retain a frame portion of a roller assembly such that the roller assembly is maintained within and between the trough and the second retaining member.

5. The holding apparatus for the paint tray of claim 1, wherein the trough includes a pair of resilient members extending from a rear wall of the trough.

6. The holding apparatus for the paint tray of claim 5, wherein the body member further includes a planar wall having an exterior surface and an opposite interior surface.

7. The holding apparatus for the paint tray of claim 6, wherein the planar wall includes a pair of openings configured to receive the pair of resilient members such that the trough is in a snap-fit configuration with the body member.

8. The holding apparatus for a paint tray of claim 7, wherein the attachment structure includes a continuous wall extending from the exterior surface of the body member, the continuous wall defines a recess, the pair of openings positioned within the recess defined by the continuous wall.

9. The holding apparatus for a paint tray of claim 8, wherein the attachment structure further includes at least one holding tang extending from the exterior surface of the planar wall.

10. The holding apparatus for a paint tray of claim 9, wherein the at least one holding tang includes a body that extends from the continuous wall and transitions at a first radius in a first direction and transitions at a second radius in a second direction opposite to the first direction to define a spring clip.

11. The holding apparatus for a paint tray of claim 10, wherein the at least one holding tang is configured to have resilient contact with the paint tray to grasp the paint tray.

12. The holding apparatus for a paint tray of claim 6, wherein at least a portion of the planar wall is positioned within an inner volume of the paint tray.

13. A holding apparatus for a paint tray comprising:
a trough having a pair of resilient members extending from a rear wall; and
a body member having:
a planar wall having an exterior surface, an opposite interior surface, and a pair of openings;
an attachment structure having:
a continuous wall extending from the exterior surface of the body member, the continuous wall defines a recess, the pair of openings positioned within the recess defined by the continuous wall; and
at least one holding tang extending from the exterior surface of the planar wall, the at least one holding tang configured to grasp a wall of the paint tray, wherein at least a portion of the planar wall is positioned within a volume of the paint tray
a first retaining member extending from the body member and positioned above the volume of the paint tray in a vertical direction; and
a second retaining member extending from the body member and positioned above the trough in the vertical direction,
wherein the pair of resilient members configured to be received by the pair of openings to releasably couple the trough to the planar wall, the trough is positioned outboard of the volume of the paint tray.

14. The holding apparatus for the paint tray of claim 13, wherein:
the first retaining member is a u-shape and configured to retain a handle of a brush such that the brush is maintained within and between the paint tray and the first retaining member; and
the second retaining member is a u-shape and configured to retain a frame of a roller assembly such that the roller assembly is maintained within and between the trough and the second retaining member.

15. The holding apparatus for a paint tray of claim 13, wherein the at least one holding tang includes a body that extends from the continuous wall and transitions at a first radius in a first direction and transitions at a second radius in a second direction opposite to the first direction to define a spring clip.

16. The holding apparatus for a paint tray of claim 13, wherein the at least one holding tang is configured to have resilient contact with the paint tray to grasp the paint tray.

17. The holding apparatus for a paint tray of claim 13, wherein at least a portion of the planar wall is positioned within an inner volume of the paint tray.

18. A holding apparatus for a paint tray having a volume comprising:
a trough having a pair of resilient members extending from a rear wall;
a body member having:
a planar wall having an exterior surface, an opposite interior surface, and a pair of openings;
an attachment structure having:
a continuous wall extending from the exterior surface of the body member, the continuous wall defines a recess, the pair of openings positioned within the recess defined by the continuous wall; and
at least one holding tang extending from the exterior surface of the planar wall, the at least one holding tang includes a body that extends from the continuous wall and transitions at a first radius in a first direction and transitions at a second radius in a second direction opposite to the first direction to define a spring clip, the at least one holding tang configured to grasp a wall of the paint tray;
a first retaining member extending from the body member and positioned above the volume of the paint tray in a vertical direction; and
a second retaining member extending from the body member and positioned above the trough in the vertical direction; and
wherein the pair of resilient members are configured to be received by the pair of openings to releasably couple the trough to the planar wall in a snap-fit configuration, the trough is positioned outboard of the volume of the paint tray and at least a portion of the planar wall is positioned within the volume of the paint tray.

19. The holding apparatus of claim 18, wherein:
the first retaining member is a u-shape and configured to retain a handle of a brush such that the brush is maintained within and between the paint tray and the first retaining member; and
the second retaining member is a u-shape and configured to retain a frame of a roller assembly such that the roller assembly is maintained within and between the trough and the second retaining member.

20. The holding apparatus of claim 18, wherein the at least one holding tang is configured to have resilient contact with the paint tray to grasp the wall of the paint tray.
